(19) United States
(12) Patent Application Publication
(10) Pub. No.: US 2022/0116189 A1
(43) Pub. Date: Apr. 14, 2022

(54) ROBUSTNESS FOR CONTROL CHANNEL

(71) Applicant: Telefonaktiebolaget LM Ericsson (publ), Stockholm (SE)

(72) Inventors: Sina MALEKI, Malmö (SE); Ali NADER, Malmö (SE); Andres REIAL, Lomma (SE)

(21) Appl. No.: 17/279,655

(22) PCT Filed: Aug. 30, 2019
(86) PCT No.: PCT/EP2019/073250

§ 371 Date: Mar. 25, 2021

Related U.S. Application Data
(60) Provisional application No. 62/738,624, filed on Sep. 28, 2018.

(51) Int. Cl. H04L 5/00

(52) U.S. Cl. CPC H04L 5/0098; H04L 5/0064; H04L 5/001

(57) ABSTRACT

A method, network node and wireless device, for releasing component carriers for wireless device power efficiency are provided. According to one aspect, the process includes receiving a component carrier-release assistance indication, CC-RAI, recommendation from the WD, the CC-RAI recommendation recommending release of at least one CC. The process may optionally include releasing at least one of the at least one component carrier. The process may also optionally include transmitting an acknowledgement to the WD acknowledging acceptance or rejection of the CC-RAI recommendation.

### TECHNICAL FIELD

The present disclosure relates to wireless communications, and in particular, to releasing component carriers for wireless device power efficiency.

### BACKGROUND

Carrier Aggregation (CA) is considered a technique to increase the total bandwidth and thereby increase the wireless device (WD) throughput as compared with non-CA communications. CA is composed of a primary carrier, and one or more secondary carrier components (CCs). While the primary carrier should always be active, the secondary CCs can be activated or deactivated. The network, such as via a network node, can configure the WD to operate in contiguous or non-contiguous CCs as well as inter and intra-band CCs.

Release Assistance Indication (RAI) is a technique in Long Term Evolution (LTE)/Narrow Band Internet of Things (NB-IoT) where the WD can inform the network node that there is no uplink (UL) data intended and further the WD does not expect a downlink (DL) data. Therefore, the WD can recommend the network node to release the connection, and if the network node accepts this recommendation, it sends the WD to the RRC-IDLE mode.

Below is more detail on the background of each of these two items.

Carrier Aggregation (CA)

Carrier aggregation is used in LTE-Advanced in order to increase the bandwidth, and thereby increase the bitrate. Since it is desirable to keep backward compatibility with 3GPP (3^{rd} Generation Partnership Project) Rel.8 and Rel.9 compatible WDs, the aggregation is based on Rel.8/Rel.9 carriers. Carrier aggregation can be used for both frequency division duplex (FDD) and time division duplex (TDD), see FIG. 1 for an example where FDD is used.

Each aggregated carrier is referred to as a component carrier, CC. In some embodiments, the component carrier can have a bandwidth of 1.4, 3, 5, 10, 15 or 20 MHz and a maximum of five component carriers can be aggregated. Hence, the maximum aggregated bandwidth is 100 MHz. In FDD, the number of aggregated carriers can be different in DL and UL, as shown in FIG. 1. However, in some embodiments, the number of uplink (UL) (from WD to network node) component carriers is always equal to or lower than the number of downlink (DL) (from network node to WD) component carriers. The individual component carriers can also be of different bandwidths. For TDD the number of CCs as well as the bandwidths of each CC will normally be the same for DL and UL.

A way to arrange aggregation is to use contiguous component carriers within the same operating frequency band (as defined for LTE), so called intra-band contiguous. This might not always be possible, due to operator frequency allocation scenarios. For non-contiguous allocation it could either be intra-band, i.e., the component carriers belong to the same operating frequency band, but have a gap, or gaps, in between, or it could be inter-band, in which case the component carriers belong to different operating frequency bands, as shown in FIG. 2.

New Radio (NR) Carrier Aggregation

The following are general considerations relating to NR carrier aggregation.

In some embodiments, the maximum number of NR carriers for CA and DC is 16)
Note, the technical standard for RAN4 currently plans to only specify requirements for intra-band UL CA;)
The number of NR CC in any aggregation is independently configured for DL and UL;
Carrier aggregation across duplexing schemes between carriers is supported;
At least CA deployment scenarios 1-4 of TS 36.300 Section J.1 are supported with equal priority;
   Carrier without synchronization signal (SS) block can be configured for some WDs;
A transport block is mapped to one carrier:
   Re-transmission of a transport block (TB) cannot take place on a different carrier than the initial transmission;
   Working assumption: Retransmission of a TB cannot take place on different numerology than the initial transmission;
   For self-scheduling, physical downlink control channel (PDCCH) and the scheduled physical downlink shared channel (PDSCH) have the same numerology;
      A WD monitors PDCCH candidates in common search space(s) at least for RMSI and WD specific search space(s) on Primary Component Carrier (PCC);
      A WD monitors PDCCH candidates at least on WD-specific search space(s) for a Secondary Component Carrier (SCC).

Release Assistance Indication (RAI)

A purpose of the Release Assistance Indication information element (IE) is to inform the network that no further uplink data transmission is expected and whether or not a downlink data transmission (e.g., acknowledgement or response) subsequent to the uplink data transmission is expected. The RAI information element is coded as shown below. The RAI is a type 1 information element.

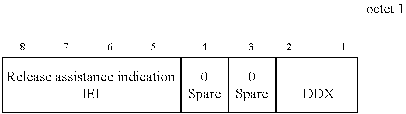

WD energy consumption in connected mode, related to DL operation, depends on receiver (RX) power consumption. When the WD is configured in several CCs, the RX components of the radio receiver chain need to operate in several CCs each in a separate RF carrier. The studies have shown that each additional CC can increase the WD power consumption by 50% to 90% compared to single-carrier operation.

Nevertheless, it is possible that due to, e.g., a change in traffic, the WD does not receive much data on one or more of these CCs. Therefore, those CCs become underutilized while consuming a significant amount of power, leading to lower WD battery life. In such a situation, particularly if the WD has already consumed a large amount of power, the battery can quickly deplete.

### SUMMARY

Some embodiments advantageously provide methods, systems, and apparatuses for releasing component carriers for wireless device power efficiency. This disclosure provides arrangements that reduce the number of CCs without compromising much on the WD throughput, thereby reducing WD power consumption and increasing battery.

A CC-RAI mechanism is disclosed by which the WD indicates to the network (NW), such as via the network node, to release one or more of the CCs. The network node can decide then based on different criteria, e.g., the buffer status and the WD throughput over each carrier, whether to accept or ignore/reject this indication.

Several embodiments of the overall solution are possible. E.g., the WD can indicate specifically which CCs it would like to have released, or just indicate the number of CCs it would like to be released. In other embodiments, the WD may request that all CCs except the primary CC be released.

The network node may furthermore interpret the CC release request as a power savings request in general, and configure the WD with operational parameters that are conducive to power savings.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of component carrier aggregation;

FIG. 2 is a diagram of alternate component carrier distributions;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating exemplary methods implemented in a communication system including a host computer, a network node and a wireless device for executing a client application at a wireless device according to some embodiments of the present disclosure;

FIG. 6 is a flowchart illustrating exemplary methods implemented in a communication system including a host computer, a network node and a wireless device for receiving user data at a wireless device according to some embodiments of the present disclosure;

FIG. 7 is a flowchart illustrating exemplary methods implemented in a communication system including a host computer, a network node and a wireless device for receiving user data from the wireless device at a host computer according to some embodiments of the present disclosure;

FIG. 8 is a flowchart illustrating exemplary methods implemented in a communication system including a host computer, a network node and a wireless device for receiving user data at a host computer according to some embodiments of the present disclosure;

FIG. 9 is a flowchart of an exemplary process in a network node for releasing component carriers for WD power efficiency according to some embodiments of the present disclosure;

FIG. 10 is a flowchart of an exemplary process in a wireless device according to some embodiments of the present disclosure; and

FIG. 11 is a flowchart of an exemplary process in a network node according to some embodiments of the present disclosure.

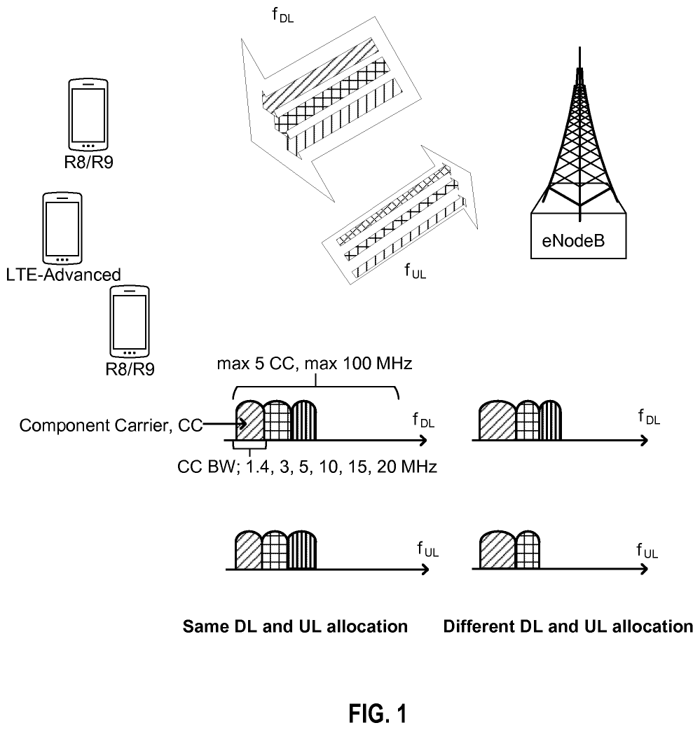

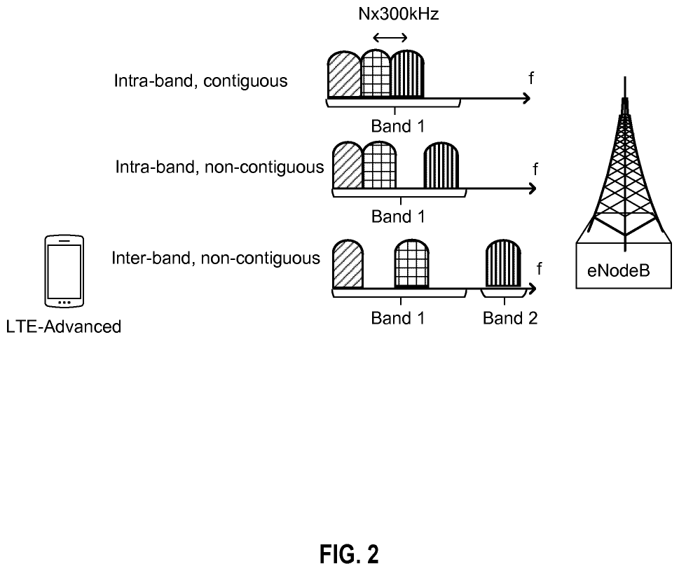

### DETAILED DESCRIPTION

Before describing in detail exemplary embodiments, it is noted that the embodiments reside primarily in combinations of apparatus components and processing steps related to releasing component carriers for wireless device power efficiency. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a mechanism for indicating to the network node from the WD that one or more carriers can be released thereby saving some power and thus enable longer battery lifetime. Note that the term “release/releasing” used throughout this disclosure aims to address both deactivation of a carrier by medium access control (MAC) control element, or e.g., a downlink control information (DCI) command on L1 level, but also the case where a CC is removed from configuration by radio resource control (RRC) signaling.

In this way, if the WD reaches a critical power status, the WD can implicitly inform the network node of the situation, and hence, the network node can make an informed decision to keep or release some or all of the secondary CCs. In case the network node confirms the recommendation of the WD in part or all together, then it sends a CC-RAI-ACK to the WD in the next PDCCH instance. If the network node decides to ignore/reject the recommendation, it does not need to send anything, and the WD knows in the next (PDCCH instance that the recommendation was rejected. However, the network node can also send a CC-RAI-NACK on the next PDCCH instance.

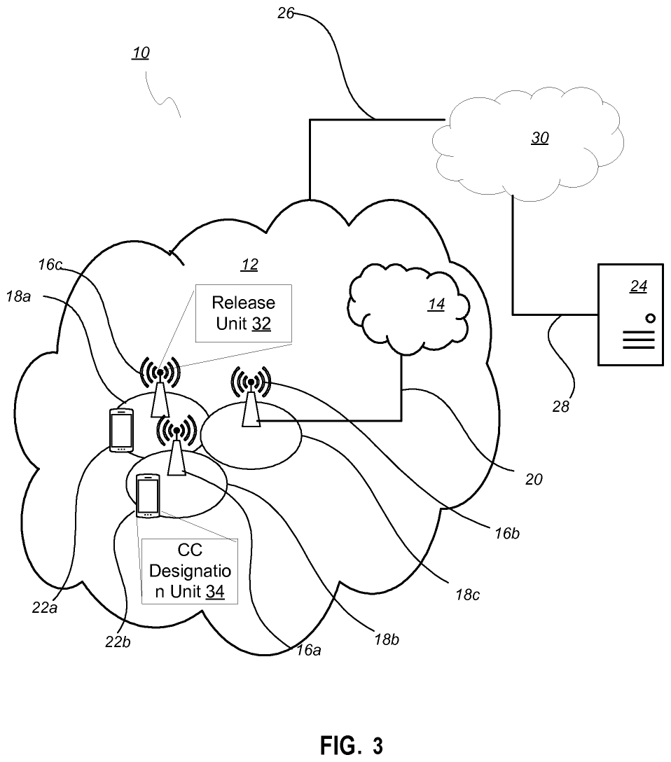

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE (Long Term Evolution) and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Release unit 32 which is configured to cause the WD 22 to release an indicated CC. A wireless device 22 is configured to include a CC designation unit 34 which is configured to designate a CC to be considered to be released by the network node.

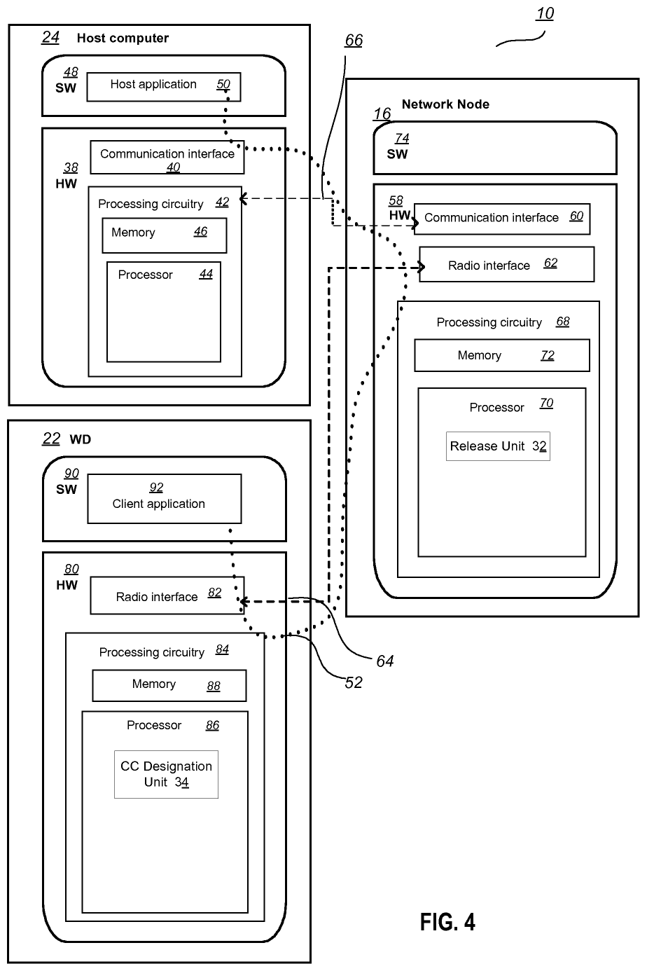

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Release unit 32 configured to cause the WD 22 to release an indicated CC.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a CC Designation unit 34 configured to designate a CC to be considered to be released by the network node 16.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as release unit 32, and CC designation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

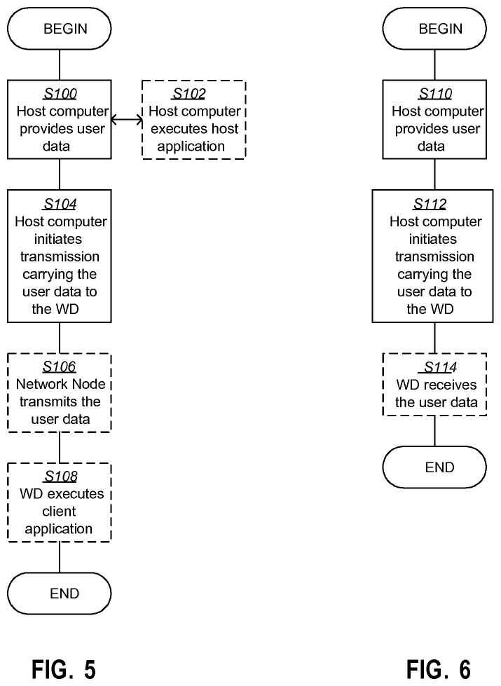

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 92, associated with the host application 50 executed by the host computer 24 (block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (block S110). In an optional substep (not shown) the host computer 24 provides the user data by executing a host application, such as, for example, the host application 50. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

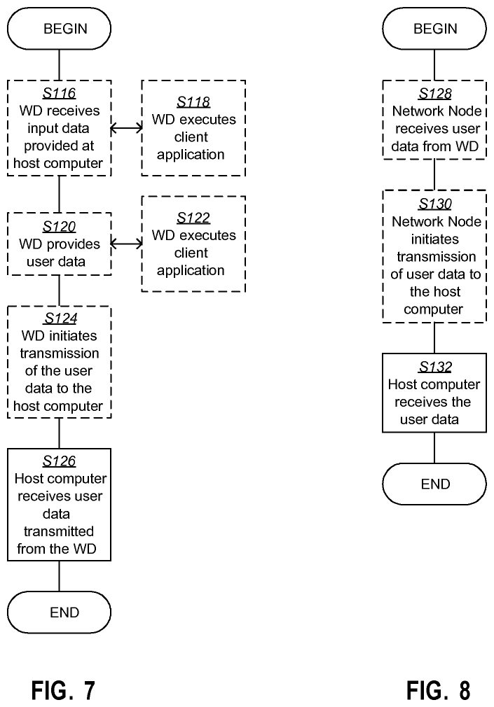

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (block S116). In an optional substep of the first step, the WD 22 executes the client application 92, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 92 (block S122). In providing the user data, the executed client application 92 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

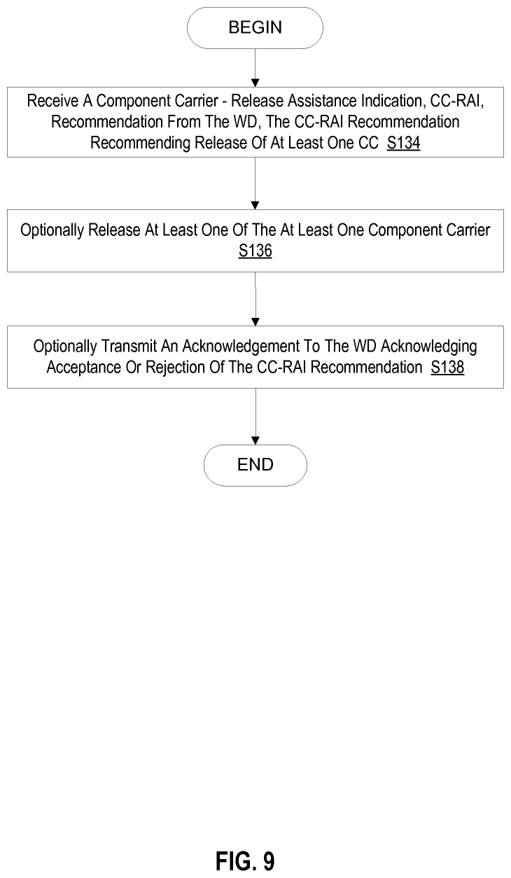

FIG. 9 is a flowchart of an exemplary process in a network node 16 according to some embodiments of the present disclosure. The process includes receiving, via the radio interface 62, a component carrier-release assistance indication, CC-RAI, recommendation from the WD, the CC-RAI recommendation recommending release of at least one CC (block S134). The process also includes optionally releasing, via the release unit 32, at least one of the at least one component carrier (block S136). The process further includes optionally transmitting, via the radio interface 62, an acknowledgement to the WD acknowledging acceptance or rejection of the CC-RAI recommendation (block S138).

According to this aspect, in some embodiments, the network node 16 rejects the CA-RAI recommendation if traffic intended for the WD 22 exceeds a threshold. In some embodiments, the network node 16 accepts or rejects, via the processor 70, the CC-RAI recommendation based on a WD 22 throughput over each of a plurality of carriers. In some embodiments, the network node 16 accepts or rejects, via the processor 70, the CC-RAI recommendation based on a latency of communications between the WD 22 and the network node 16. In some embodiments, the network node 16 accepts, via the processor 70, the CC-RAI recommendation at least in part if a release of a component carrier is not expected by the network node 16 to cause significant degradation of a metric monitored by the network node 16.

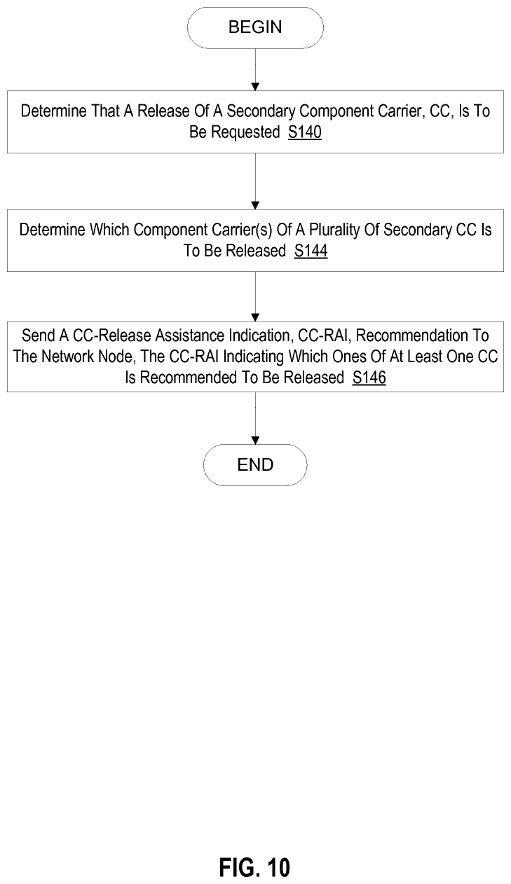

FIG. 10 is a flowchart of an exemplary process in a wireless device 22 according to some embodiments of the present disclosure. The process includes determining, via the processor 86, that a release of a secondary component carrier, CC, is to be requested (block S140). The process also includes determining, via the CC designation unit 34, which component carrier(s) of a plurality of secondary CC is to be released (block S144). The process also includes sending, via the radio interface 82, a CC-release assistance indication, CC-RAI, recommendation to the network node, the CC-RAI indicating which ones of at least one CC is recommended to be released (block S146).

According to this aspect, in some embodiments, the WD 22 monitors, via the processor 86, a physical downlink control channel, PDCCH, to determine if an acknowledgement has been sent by the network node 16. In some embodiments, if the acknowledgement is received, the WD 22 deactivates, via the processor 86, an indicated secondary CC.

Having described the general process flow of arrangements of the disclosure and having provided examples of hardware and software arrangements for implementing the processes and functions of the disclosure, the sections below provide details and examples of arrangements for releasing component carriers for wireless device power efficiency.

CC-RAI Design

One example of designing CC-RAI is to send the signal through the physical uplink control channel (PUCCH) or the physical uplink shared channel (PUSCH) to the network node 16. For example, the signaling may be carried out on the layer 1 (L1) level by introducing CC-RAI in Uplink Control Information (UCI) on the PUCCH/PUSCH. Another example is to use CC-RAI in a layer 2 (L2) MAC Control Element provided in the UL on PUSCH, or on the layer 3 (L3) level through RRC signaling.

Such a signal could indicate to the network node 16 to release all the CCs, revealing to the network node 16 that the WD 22 battery is in a critical status, or ask the network node 16 to release one or more of the CCs. In the latter case, the WD 22 could also be more specific about which CCs to release.

CC-RAI-ACK Design

One example of designing a CC-RAI-ACK is to define a new DCI or use the free bits available in the currently existing PDCCH DCI formats (e.g., format 1-0) either confirming the whole recommendation of the WD 22 or indicating to the WD 22 which CCs can be released. Another way is to use existing RRC/MAC release/deactivation mechanisms instead of a specific ACK, i.e., if the network node 16 agrees, it simply removes the CC.

CC-RAI-NACK (Optional)

This signal is optional to the network node 16 as if it wishes to ignore/reject the WD 22 recommendation, it does not need to send anything and thereby the WD 22 will know that its recommendation is rejected and the configuration should remain as it is. However, if it wishes so, the network node 16 can, similar to the above, define a new DCI or use free bits currently existing in the physical downlink control channel, PDCCH DCI formats (e.g. 1-0) to reject the WD 22's request.

An example of a high-level flow of some embodiments at the WD 22 is described as follows:

| | |
|---|---|
| P90 | The WD 22 is configured by the network node 16 to be |
| | allowed to send CC-RAI if necessary; |
| P100 | The WD 22 determines that a secondary CC release |
| | is desirable; |
| P110 | The WD 22 decides which secondary CCs or all of |
| | them can be released; |
| P120 | The WD 22 sends the CC-RAI signal; |
| P130 | The WD 22 in the next PDCCH transmission looks |
| | for CC-RAI-ACK; and |
| P140 | If the WD 22 has received the CC-RAI-ACK, it |
| | deactivates the indicated secondary CCs |

As reflected in the flow, the CC-RAI can be used when the WD 22 power level reaches a critical point determined by a threshold X % (i.e., the WD 22 power level<X %). However, to do so—as is clear in step P90—the WD 22 may already been configured by the network node 16 to be allowed to send CC-RAI.

In step P100, the WD 22 determines that a secondary CC release is desirable. For example, the WD 22 may monitor its available energy reserve, e.g., the battery status, and if it is below the critical threshold of X %, the process moves to the next step, i.e., step P110. Other motivations for release may be, e.g., an opportunity for overall energy conservation (regardless of the current battery state) due to low expected data transmission. Such expected indication may be obtained, e.g., from smartphone app status information or other buffer status info from intermediate protocol levels.

In step P110, the WD 22 decides which secondary CCs or all of them can be released. This decision can be made based on a trade-off between different components, e.g., the WD 22 throughput on a specific carrier, frequency, power consumption, latency, and expected traffic.

In step P120, the WD 22 sends the CC-RAI signal to the NW over, e.g., the PUCCH/PUSCH.

In step P130, the WD 22 monitors the next PDCCH and particularly looks for a possible CC-RAI-ACK from the network node 16. If such a signal is received, then the WD 22 understands which secondary CCs can be released.

In step P140, the WD 22 releases the secondary CCs indicated in the CC-RAI-ACK. If release of all secondary CCs is permitted/indicated by the network node 16, the WD 22 releases all of secondary CCs.

An example high-level flow of some embodiments at the network node 16 (e.g., gNB) side is depicted below. Matching steps with the WD 22 flow are indicated in bold (offset by “200”); details in those steps provided in the network node 16 description above also apply to the WD 22 flow.

| | |
|---|---|
| P320 | The network node 16 receives CC-RAI; |
| P321 | The network node 16 decides to ignore or evaluate |
| | CC-RAI recommendation; |
| P322 | The network node 16 decides to accept CC-RAI |
| | recommendations in all or in part (opt); |
| P330 | The network node 16 sends a CC-RAI-ACK if it accepts |
| | the CC-RAI recommendations at least in part, or the |
| | network node 16 chooses to send an optional |
| | CC-RAI-NACK if it would like to reject CC-RAI. |

In step P320, the network node 16 receives CC-RAI.

In step P321, the network node 16 decides whether to evaluate the CC-RAI recommendation or ignore it all together. The network node 16 does not necessarily need a reason for ignoring it, however, one example can be high traffic intended for the WD 22 which otherwise cannot be accommodated.

In step P322, if the network node 16 decides to evaluate the CC-RAI recommendations, then it starts its procedure to do so. This procedure is up to the network node 16 to be designed, however as some non-limiting examples, the design can be a trade-off between different components such as the traffic intended for the WD 22, the WD 22 throughput over each carrier, and latency. Based on such analysis, if the release is not expected to cause significant degradation of the metrics of interest, the network node 16 can accept the CC-RAI decision in all or in part.

In step P330, the network node 16 forms a CC-RAI-ACK to be sent over the next PDCCH instance to the WD 22 if the outcome of step P322 is positive. However, if the decision in step P322 is to reject the CC-RAI recommendations, the network node 16 does not have to necessarily send anything to the WD 22. If it wishes so, the network node 16 can send a CC-RAI-NACK to the WD 22 indicating the rejection of the recommendation in some embodiments.

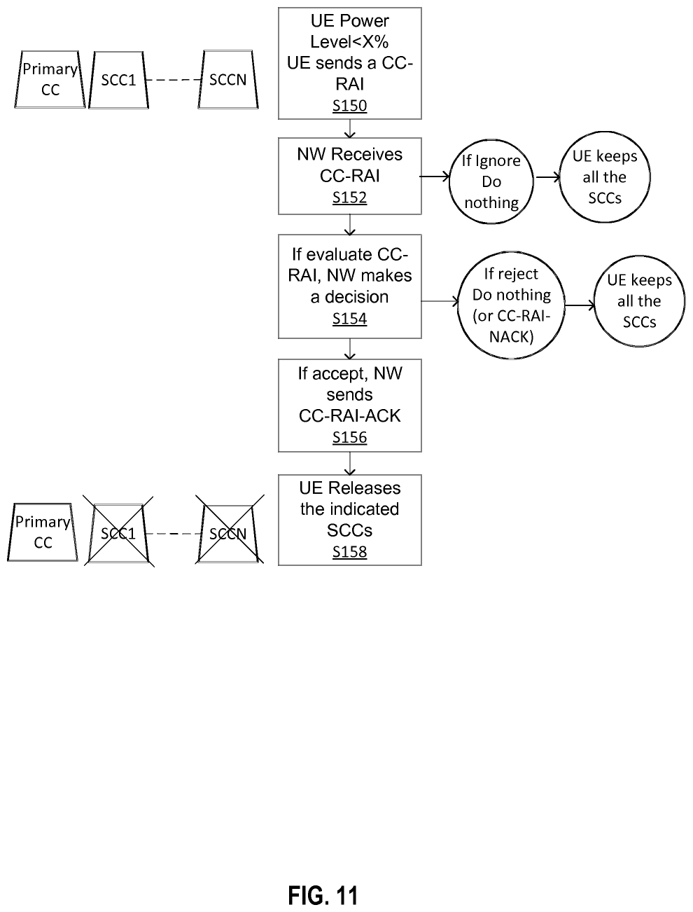

The above described process is depicted graphically in FIG. 11. The time diagram shows how the CC-RAI may assist the network node 16 to decide in favor of the WD 22 to drop some or all of the secondary CCs (SCC). In this way, the WD 22 may save some of its battery energy, leading to a longer battery life. However, as depicted above, the network node 16 has the option of ignoring or rejecting the WD 22 recommendations altogether. In step S150, the WD 22 determines if its power level is below a threshold and sends a CC-RAI if the power level is below the threshold. In step S152, the network node 16 receives the CC-RAI. If the network node 16 ignores the CC-RAI then the WD 22 does nothing in response and the WD 22 keeps all active secondary CCs. In step S154, the network evaluates the CC-RAI and makes a decision. If the network rejects the CC-RAI recommendation then it either refrains from responding to the WD 22 or sends a non-acknowledgement to the WD 22, in which case, the WD 22 keeps all secondary CCs active. In step S156, the network node 16 accepts the CC-RAI recommendation and sends an acknowledgement to the WD 22. In this case, in step S158, the WD 22 releases the indicated secondary CCs.

Extensions

In one embodiment, the network node 16 may use the CC-RAI request from a WD 22, especially if the request entails releasing all secondary CCs, as an indicator that the WD 22 prefers highly energy-efficient operation. The network node 16 may then, in addition to or instead of releasing CCs, configure the WD 22 in power-efficient PDCCH search spaces (low-bandwidth (BW) and/or spares tin time), in connected mode discontinuous reception (C-DRX) or idle mode discontinuous (I-DRX) with low on-time duty cycle, etc.

In the examples mentioned above, the CC RAI indication is used by the WD 22 in need of saving battery power. However, the methods herein could equally be used by the WD 22 for any other reason, e.g., too high temperature experienced such as due to processing load.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

Embodiment A1. A network node configured to communicate with a wireless device (WD), the network node configured to, and/or comprising a radio interface and/or comprising processing circuitry configured to:

receive a component carrier-release assistance indication, CC-RAI, recommendation from the WD, the CC-RAI recommendation recommending release of at least one CC;

optionally release at least one of the at least one component carrier; and

optionally transmit an acknowledgement to the WD acknowledging acceptance or rejection of the CC-RAI recommendation.

Embodiment A2. The network node of Embodiment A1, wherein the network node rejects the CA-RAI recommendation if traffic intended for the WD exceeds a threshold.

Embodiment A3. The network node of Embodiment A1, wherein the network node accepts or rejects the CC-RAI recommendation based on a WD throughput over each of a plurality of carriers.

Embodiment A4. The network node of Embodiment A1, wherein the network node accepts or rejects the CC-RAI recommendation based on a latency of communications between the WD and the network node.

Embodiment A5. The network node of Embodiment A1, wherein the network node accepts the CC-RAI recommendation at least in part if a release of a component carrier is not expected by the network node to cause significant degradation of a metric monitored by the network node.

Embodiment B1. A method implemented in a network node, the method comprising:

receiving a component carrier-release assistance indication, CC-RAI, recommendation from the WD, the CC-RAI recommendation recommending release of at least one CC;

optionally releasing at least one of the at least one component carrier; and

optionally transmitting an acknowledgement to the WD acknowledging acceptance or rejection of the CC-RAI recommendation.

Embodiment B2. The method of Embodiment B1, wherein the network node rejects the CA-RAI recommendation if traffic intended for the WD exceeds a threshold.

Embodiment B3. The method of Embodiment B1, wherein the network node accepts or rejects the CC-RAI recommendation based on a WD throughput over each of a plurality of carriers.

Embodiment B4. The method of Embodiment B1, wherein the network node accepts or rejects the CC-RAI recommendation based on a latency of communications between the WD and the network node.

Embodiment B5. The method of Embodiment B1, wherein the network node accepts the CC-RAI recommendation at least in part if a release of a component carrier is not expected by the network node to cause significant degradation of a metric monitored by the network node.

Embodiment C1. A wireless device (WD) configured to communicate with a network node, the WD configured to, and/or comprising a radio interface and/or processing circuitry configured to

determine that a release of a secondary component carrier, CC, is to be requested;

determine which component carrier(s) of a plurality of secondary CC is to be released; and

send a CC-release assistance indication, CC-RAI, recommendation to the network node, the CC-RAI indicating which ones of at least one CC is recommended to be released.

Embodiment C2. The WD of Embodiment C1, wherein the WD monitors a physical downlink control channel, PDCCH, to determine if an acknowledgement has been sent by the network node.

Embodiment C3. The WD of Embodiment C2, wherein, if the acknowledgement is received, the WD deactivates an indicated secondary CC.

Embodiment D1. A method implemented in a wireless device (WD), the method comprising:

determining that a release of a secondary component carrier, CC, is to be requested;

determining which component carrier(s) of a plurality of secondary CC is to be released; and

sending a CC-release assistance indication, CC-RAI, recommendation to the network node, the CC-RAI indicating which ones of at least one CC is recommended to be released.

Embodiment D2. The method of Embodiment D1, wherein the WD monitors a physical downlink control channel, PDCCH, to determine if an acknowledgement has been sent by the network node.

Embodiment D3. The method of Embodiment D2, wherein, if the acknowledgement is received, the WD deactivates an indicated secondary CC.

1. A network node configured to communicate with a wireless device, the network node comprising a radio interface and processing circuitry configured to:
receive a component carrier-release assistance indication, CC-RAI, recommendation from the WD, the CC-RAI recommendation recommending release of at least one CC;
release at least one of the at least one component carrier; and
transmit an acknowledgement to the WD acknowledging one of acceptance and rejection of the CC-RAI recommendation.

2. The network node of claim 1, wherein the network node rejects the CA-RAI recommendation if traffic intended for the WD exceeds a threshold.

3. The network node of claim 1, wherein the network node one of accepts and rejects the CC-RAI recommendation based on a WD throughput over each of a plurality of carriers.

4. The network node of claim 1, wherein the network node one of accepts and rejects the CC-RAI recommendation based on a latency of communications between the WD and the network node.

5. The network node of claim 1, wherein the network node accepts the CC-RAI recommendation at least in part if a release of a component carrier is not expected by the network node to cause significant degradation of a metric monitored by the network node.

6. A method implemented in a network node, the method comprising:
receiving a component carrier-release assistance indication, CC-RAI, recommendation from a wireless device (WD), the CC-RAI recommendation recommending release of at least one CC;
releasing at least one of the at least one component carrier; and
transmitting an acknowledgement to the WD acknowledging one of acceptance and rejection of the CC-RAI recommendation.

7. The method of claim 6, wherein the network node rejects the CA-RAI recommendation if traffic intended for the WD exceeds a threshold.

8. The method of claim 6, wherein the network node one of accepts and rejects the CC-RAI recommendation based on a WD throughput over each of a plurality of carriers.

9. The method of claim 6, wherein the network node one of accepts and rejects the CC-RAI recommendation based on a latency of communications between the WD and the network node.

10. The method of claim 6, wherein the network node accepts the CC-RAI recommendation at least in part if a release of a component carrier is not expected by the network node to cause significant degradation of a metric monitored by the network node.

11. A wireless device (WD) configured to communicate with a network node, the WD comprising a radio interface and processing circuitry configured to:
determine that a release of a secondary component carrier, CC, is to be requested;
determine which component carrier(s) of a plurality of secondary CC is to be released; and
send a CC-release assistance indication, CC-RAI, recommendation to the network node, the CC-RAI indicating which ones of at least one CC is recommended to be released.

12. The WD of claim 11, wherein the WD monitors a physical downlink control channel, PDCCH, to determine if an acknowledgement has been sent by the network node.

13. The WD of claim 12, wherein, if the acknowledgement is received, the WD deactivates an indicated secondary CC.

14. A method for wireless device (WD), the method comprising:
sending a CC-release assistance indication, CC-RAI, recommendation to a network node, the CC-RAI indicating which component carrier(s) of at least one secondary CC is recommended to be released.

15. The method of claim 14, further comprising monitoring a physical downlink control channel, PDCCH, to determine if an acknowledgement has been sent by the network node.

16. The method of claim 15, wherein if the acknowledgement is received, the WD deactivates an indicated secondary CC.

17. A computer storage medium storing a computer program comprising instructions which, when executed on a processor of a network node causes the network node to perform a method, the method comprising:
receiving a component carrier-release assistance indication, CC-RAI, recommendation from a wireless device (WD), the CC-RAI recommendation recommending release of at least one CC;
releasing at least one of the at least one component carrier; and
transmitting an acknowledgement to the WD acknowledging one of acceptance and rejection of the CC-RAI recommendation.

18. (canceled)
